(19) United States
(12) Patent Application Publication
(10) Pub. No.: US 2023/0070813 A1
(43) Pub. Date: Mar. 9, 2023

(54) CARRIER FOR IRRADIATED TARGET AND DISSOLUTION SYSTEM FOR PRODUCING SOLUTION OF SAME

(71) Applicant: SOCIETE DE COMMERCIALISATION DES PRODUITS DE LA RECHERCHE APPLIQUÉE SOCPRA SCIENCES ET GÉNIE S.E.C., Sherbrooke (CA)

(72) Inventors: Brigitte GUERIN, Sherbrooke (CA); Sébastien TREMBLAY, Sherbrooke (CA); Jean-François BEAUDOIN, Sherbrooke (CA)

(21) Appl. No.: 17/800,128

(22) PCT Filed: Apr. 9, 2020
(86) PCT No.: PCT/CA2020/050477

§ 371 Date: Aug. 16, 2022

Related U.S. Application Data
(60) Provisional application No. 62/833,058, filed on Apr. 12, 2019.

(51) Int. Cl. G21K 5/08; G21G 1/00

(52) U.S. Cl. CPC G21K 5/08; G21G 1/001

(57) ABSTRACT

A carrier for an irradiated target includes a first portion and a second portion having inner walls. One or both of the first and second portions has a recess extending inwardly from the inner wall thereof to receive the irradiated target. The first and second portions are removably attachable in sealing engagement. The inner walls face each other and form a barrier around the recess upon the first and second portions being removably attached. A fastening system provided on one or both of the first and second portions maintains the first and second portions in sealing engagement. There is also disclosed a kit of the carrier and the irradiated target, a dissolution system for producing a solution from the irradiated target, and a corresponding method.

### CROSS-REFERENCE TO RELATED APPLICATIONS

This application claims priority to US provisional patent application having application No. 62/833,058 and filed on Apr. 12, 2019, the entire contents of which are incorporated by reference herein. Reference is also made to International patent application having application number PCT/CA2019/051777 filed Dec. 10, 2019, and to US provisional patent application having application No. 62/777,994 and filed on Dec. 11, 2018, the entire contents of both of which are incorporated by reference herein.

### TECHNICAL FIELD

The application relates generally to devices for irradiated materials known as targets, and more particularly, to a carrier and dissolution system for irradiated targets.

### BACKGROUND

Radiometals such as gallium-68 (⁶⁸Ga) may be produced and/or purified from an irradiated solid, pressed target of zinc-68 (⁶⁸Zn). ⁶⁸Ga is a positron-emitting radioactive isotope with a short half-life (t_{1/2}=68 min). Because of this short half-life, it is critical that ⁶⁸Ga be produced with high yield and high purity to minimize or entirely alleviate the need for extensive and time-consuming purification steps. It is also important that ⁶⁸Ga be handled safely and conveniently to minimize time-consuming steps related to its containment, transportation, and processing.

### SUMMARY

The following elements are disclosed:

A. A carrier for an irradiated target, comprising: a first portion and a second portion having inner walls and one or both of the first and second portions having a recess extending inwardly from the inner wall thereof to receive the irradiated target, the first and second portions being removably attachable in sealing engagement, the inner walls facing each other and forming a barrier around the recess upon the first and second portions being removably attached; and a fastening system provided on one or both of the first and second portions to maintain the first and second portions in sealing engagement.

B. A kit, comprising: a solid irradiated target; and a carrier for the solid irradiated target, the carrier comprising: a first portion and a second portion having inner walls and one or both of the first and second portions having a recess extending inwardly from the inner wall thereof and containing the solid irradiated target, the first and second portions being removably attached in sealing engagement and separable from each other, the inner walls facing each other and forming a barrier around the solid irradiated target in the recess; and a fastening system provided on one or both of the first and second portions to maintain the first and second portions in sealing engagement.

C. A dissolution system for producing a solution of irradiated target, the system comprising: a reactor shaped and sized to contain a solvent for dissolving the irradiated target; a grip assembly having a first plate displaceable relative to a second plate between an open position and a closed position, the first and second plates in the open position defining an opening therebetween to receive a carrier containing the irradiated target, the first and second plates in the closed position gripping the carrier, displacement of the first and second plates from the closed position to the open position separating portions of the carrier to release the irradiated target therefrom; and a passage extending between the reactor and the grip assembly to selectively communicate the irradiated target released from the grip assembly to the reactor.

D. A method of producing a solution of irradiated target, the method comprising: retaining a carrier containing the irradiated target between two displaceable plates; and displacing the plates away from each other to release the irradiated target into a reactor containing a solvent for dissolving the irradiated target.

The following additional features are also disclosed, and may be combined in any combination with each other and with the elements A, B, C and D mentioned above:

The first portion has a first segment extending along a length of a periphery of the first portion, the second portion has a second segment extending along a length of a periphery of the second portion, the fastening system including attachment members of the first and second segments, the attachment members being removably attachable to maintain the first and second portions in sealing engagement.

The first and second segments are aligned upon the first and second portions being in sealing engagement.

The attachment members include magnets, the magnets of the first segment having a first polarity and the magnets of the second segment having a second polarity opposite to the first polarity.

The magnets are disposed within the first and second segments, the magnets having a length less than a length of the first and second segments.

The magnets define exposed magnet faces for the first and second segments, the exposed magnet face of the first segment abutting the exposed magnet face of the second segment upon the first and second portions being in sealing engagement.

The recess is spaced apart from the first and second segments.

The first and second portions are rounded and define a center axis of the carrier, the recess being coaxial with the center axis.

The first and second portions are made from a weakly activable material being aluminum (Al).

The first and second portions are made from a weakly activable material being one of aluminum (Al), Niobium (Nb), Silver (Ag), Tantalum (Ta), Rhodium (Rh), Platinum (Pt), Copper (Cu) and alumina ceramic.

One or both of a thickness of the barrier and a depth of the recess are selected to provide the carrier with an energy degradation effect.

A thickness of the barrier is selected to provide the carrier with an energy degradation effect.

The thickness of the first portion is different from a thickness of the second portion to provide the carrier with the energy degradation effect.

The recess is a first recess extending inwardly from the inner wall of the first portion, the second portion having a second recess extending inwardly from the inner wall of the first portion and aligned with the first recess.

The recess is a first recess extending inwardly from the inner wall of the first or second portions, the first and second portions having a plurality of other recesses extending inwardly from the inner walls of the first or second portions, the plurality of other recesses spaced apart from each other and from the first recess.

The first and second portions are spherically shaped, the first and second portions being removably attachable in sealing engagement to form the carrier having a spherical shape.

The solid irradiated target is a disc or a sphere.

The solid irradiated target has a first diameter and the recess has a second diameter greater than the first diameter.

The solid irradiated target includes Zinc-68 (⁶⁸Zn).

The solid irradiated target includes one of Zinc-68 (⁶⁸Zn), Molybdenum-100 (¹⁰⁰Mo), Yttrium-89 (⁸⁹Y), Scandium-45 (⁴⁵Sc), Calcium-44 (⁴⁴Ca), Tin-119 (¹¹⁹Sn), and Nickel-64 (⁶⁴Ni).

The carrier is a first carrier, the kit comprising one or more additional carriers removably stacked with the first carrier.

The first and second portions are rectangular prisms, the first and second portions being removably attachable in sealing engagement to form the carrier having a rectangular prism shape.

At least one of the first and the second plates has a support to support part of the carrier.

The support includes a vacuum orifice extending through the at least one of the first and the second plates and in fluid communication with a negative-pressure source.

Displacement of the first and second plates from the closed position to the open position separates portions of the carrier to release the irradiated target therefrom, and maintains the separated portions of the carrier on the first and second plates.

A closure member displaceable to selectively obstruct the passage and prevent communication of the irradiated target released from the grip assembly to the reactor.

The passage defines a passage width being greater than a corresponding dimension of the irradiated target to communicate the irradiated target released from the grip assembly to the reactor, the passage width being less than a corresponding dimension of the carrier to block movement of the carrier along the passage.

A carrier passage extending between the first and second plates and a discharge outlet to convey the carrier away from the gripping assembly.

A valve to seal the reactor.

The reactor has a gas line and a liquid line, the valve being closable to seal the reactor and transfer a solution therein under pressure via the liquid line.

Retaining the carrier includes retaining a portion of the carrier against one of the plates with a negative pressure, and retaining another portion of the carrier against the other plate with a negative pressure.

Displacing the plates away from each other includes releasing the irradiated target through a passage leading to the reactor, the method comprising blocking displacement of the carrier into the passage.

Selectively blocking release of the irradiated target into the reactor.

Displacing the plates toward each other after the irradiated target has been released into the reactor, to reassemble portions of the carrier.

Releasing the reassembled carrier from the plates and away from the reactor.

Evacuating the solution of irradiated target from the reactor by applying negative or positive pressure.

### DESCRIPTION OF THE DRAWINGS

Reference is now made to the accompanying figures in which:

FIG. 1A is an exploded view of a carrier for an irradiated target;

FIG. 1B is another exploded view of the carrier of FIG. 1A, a first portion thereof having portions being shown transparent;

FIG. 1C is a cross-sectional view of the carrier of FIG. 1A;

FIG. 2A is an exploded view of another carrier for an irradiated target;

FIG. 2B is a cross-sectional view of the carrier of FIG. 2A;

FIG. 3 is an exploded view of another carrier for an irradiated target;

FIG. 4A is an exploded view of another carrier for an irradiated target;

FIG. 4B is a cross-sectional view of the carrier of FIG. 4A;

FIG. 5 is an exploded view of another carrier for an irradiated target;

FIG. 6 is an exploded view of another carrier for an irradiated target;

FIG. 7A is an assembled view of a stack of carriers of irradiated targets;

FIG. 7B is an exploded view of the stack of FIG. 7A showing the carriers and the irradiated targets;

FIG. 8A is a perspective view of a dissolution system for producing a liquid solution from an irradiated target using a carrier;

FIG. 8B is an enlarged view of part of the system of FIG. 8A;

FIG. 8C is an enlarged view of another part of the system of FIG. 8A;

FIG. 8D is a view of the same part of the system as shown in FIG. 8B, the carrier and the irradiated target being shown assembled;

FIG. 8E shows the carrier separated from the irradiated target;

FIG. 8F shows the carrier being released from the system;

FIG. 8G shows the carrier released from the system; and

FIG. 9 is an exploded view of another carrier for an irradiated target.

### DETAILED DESCRIPTION

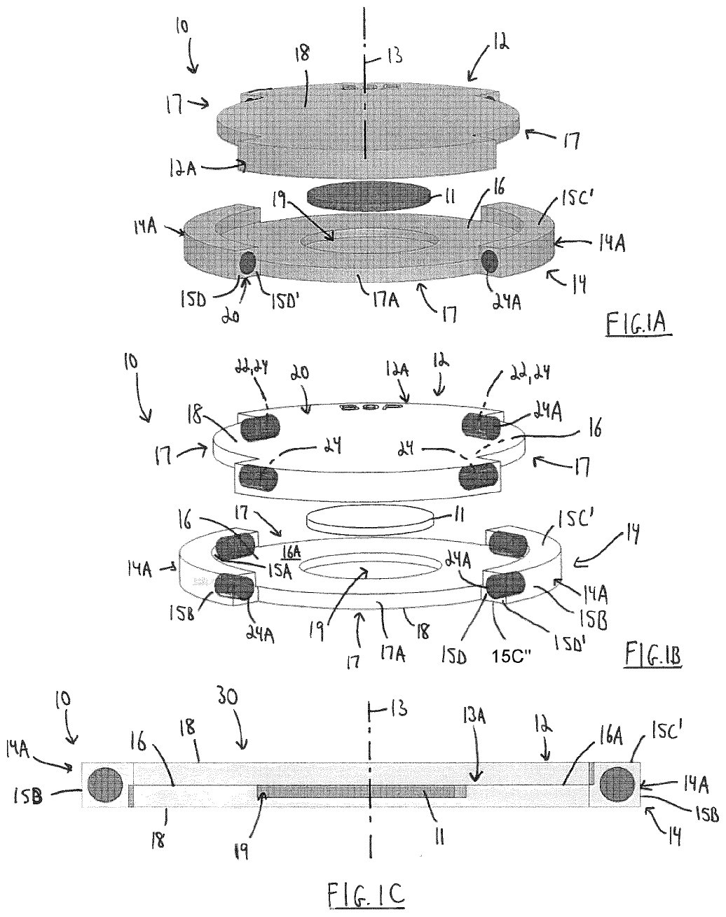

FIGS. 1A and 1B show a carrier 10 for a target 11. The carrier 10 is an object used to safely and securely support, transport, and dispose of the irradiated target 11. The carrier 10 may thus take any suitable shape or form to achieve this functionality, and is not limited to the shape or form shown in the figures or disclosed herein. The carrier 10 is used primarily with the target 11 before it has been irradiated. The carrier 10 may also be used after the target 11 has been irradiated, such as during transport of the target 11 within the carrier 10. “Irradiated” therefore refers to a target 11 that is, or will be, irradiated to produce a radioactive isotope of the target 11. One example of an irradiated solid target 11 that is supported, transported, and disposed of by the carrier 10 is Zinc-68 (⁶⁸Zn) for the production of Gallium-68 (⁶⁸Ga). When used with ⁶⁸Zn, the carrier 10 is a hardware component that may be used for radioactive ⁶⁸Ga production. The carrier 10 also degrades or reduces the energy of the particles used to irradiate the target 11 contained in the carrier 10.

In FIG. 10, the irradiated target 11 is in the form of a solid, pressed disc. Other shapes for the irradiated target 11 are also possible, and some possible shapes are described in greater detail below. One possible technique for producing the disc-shaped irradiated target 11 in FIG. 10 is now described. A quantity of powder of ⁶⁸Zn is inserted into dies of different diameters (e.g. 6 mm, 8 mm, and 10 mm) and pressed using a suitable press, such as a digital hydraulic carver press (Module number: 3912, Carver, Inc, Wabash, Ind., US) at a suitable pressure depending on the size of the disc to produce. The ⁶⁸Zn-pressed disc, sometimes referred to as a “solid target”, may then be inserted into an appropriately-sized carrier 10. The carrier 10 with the ⁶⁸Zn-pressed disc is then irradiated, such as by an accelerated particle beam, to form the irradiated target 11. The irradiated target 11 includes ⁶⁸Zn to produce ⁶⁸Ga. The irradiated target 11 may be composed of other precursor materials to produce different radioactive isotopes. Non-limiting examples of other precursor metals for the irradiated target 11 include ¹⁰⁰Mo, ⁸⁹Y, ⁴⁵Sc, ⁴⁴Ca, ¹¹⁹Sn and ⁶⁴Ni to produce ^{99m}Tc, ⁸⁹Zr, ⁴⁵Ti, ⁴⁴Sc, ¹¹⁹Sb and ⁶⁴Cu, respectively.

Referring to FIGS. 1A and 1B, the carrier 10 includes a first portion 12 and a second portion 14 that are attachable together, and separable from one another, to receive the non-irradiated target 11, to support it during irradiation, and to protect it from contamination during transportation. The first and second portions 12,14 are made from a weakly activable material. A “weakly activable” material in the present disclosure is a material which can be repeatedly subjected to, or treated with, radiation to irradiate the target 11 therein, while not being significantly subject to induced radiation activation, so that the carrier 10 may be reused.

In FIGS. 1A and 1B, the weakly activable material is aluminum (Al). The first and second portions 12,14 made of Al are strong thermal conductors and serve as conduits, which help to dissipate or conduct the heat generated by the target 11 during irradiation. Making the first and second portions 12,14 from Al also allows for a better control of the density and thickness of the first and second portions 12,14, so that the carrier 10 can be designed to have a good distribution of energy to the target 11 during irradiation. Both the first and second portions 12,14 interpose a quantity of matter between the target 11 along a center axis 13 of the carrier 10. This matter degrades the particle beam to the desired energy threshold to produce the desired radio-isotope. Making the carrier 10 from Al helps it to act as an integrated particle energy degrader. Al thus makes it possible to create a custom-made, ⁶⁸Zn-pressed target carrier 10. Making the first and second portions 12,14 from Al may also lower the manufacturing costs of the carrier 10, because Al is a widely-available metal. In an embodiment, the weakly activable material from which the first and second portions 12,14 are made is 6061-T6 Al alloy. The first and second portions 12,14 may also be made from other weakly activable materials, or from different weakly activable materials. Some non-limiting examples of other materials include Niobium (Nb), Silver (Ag), Tantalum (Ta), Rhodium (Rh), Platinum (Pt), Copper (Cu) and alloys of these, Havar, or alumina ceramic. More sophisticated designs can include custom alloys or a plated insert in the discs to achieve the desired energy degradation at the surface where the particle beam makes contact with the carrier 10.

Still referring to FIGS. 1A and 1B, the first and second portions 12,14 each have inner walls 16 and outer walls 18. The inner walls 16 face each other when the first and second portions 12,14 are attached and the carrier 10 is “closed”. The outer walls 18 are exposed to the environment surrounding the carrier 10. The inner walls 16 define inner surfaces 16A of the first and second portions 12,14. In FIGS. 1A and 1B, the second portion 14 has a single recess 19 that extends inwardly into the body of the second portion 14 from the inner surface 16A of the second portion 14. The recess 19 does not extend through the entire second portion 14. The recess 19 has a depth that is less than a distance between the inner surface 16A and the outer wall 18 of the second portion 14. The recess 19 is a pocket or cavity in the second portion 14 that is shaped and sized to receive the solid target 11. Other configurations of the carrier 10 may have multiple recesses 19, examples of which are described below.

The shape and size of the recess 19 may thus vary, and are primarily chosen as a function of the shape and size of the irradiated target 11 and the particle beam shape. For example, in FIGS. 1A and 1B, the shape of the recess 19 is cylindrical. The depth of the recess 19 is 0.55 mm, measured from the inner surface 16A of the second portion 14. The diameter of the recess 19 is selected to accommodate the disc-shaped irradiated target 11. Thus, if the disc-shaped irradiated target 11 has diameter of 6, 8 and 10 mm, the cylindrical recess 19 will have an internal diameter of 7, 9 or 11 mm, respectively. The recess 19 in FIGS. 1A and 1B is therefore slightly larger than the size of the irradiated target 11 (e.g. in this example, by about 1 mm). The larger recess 19 allows the smaller target 11 to be easily inserted into the recess 19, and to slide/fall out of the recess 19 once irradiated for further treatment when the first and second portions 12,14 are separated from each other, as described in greater detail below. The recess 19 in the depicted embodiment is coaxial with the center axis 13 of the round carrier 10. In an alternate embodiment, only the first portion 12 has the recess 19.

In another configuration, an example of which is shown in FIGS. 2A and 2B, the carrier 110 has more than one recess 19. Features of the carrier 110 shown in FIGS. 2A and 2B which are not annotated with a reference number bear the same reference number as a similar feature shown in the carrier 10 described above and shown in the other figures. In FIGS. 2A and 2B, the first portion 112 has a first recess 119A and the second portion 114 has a second recess 119B. In FIGS. 2A and 2B, the first and second recesses 119A,119B are of equal size such that there is no distinction between the first and second portions 112,114. In an alternate configuration, the first and second recesses 119A,119B have different shapes or sizes. The carrier 10 and/or the recess 19 may also assume other shapes, including but not limited to, rectangular, square and oval, some of which are described in greater detail below. In addition, the solid target 11 could also assume different shapes, such as a sphere described in greater detail below, as well non-circular forms such as rectangular, square, cubic, and oval. In such configurations, the carrier 10 and/or its recess 19 may have three-dimensional forms to accommodate the target 11 being a sphere or different varieties of polyhedrons. The carrier 10, target 11 and/or the recess 19 are therefore not limited in shape and may take the form of other tridimensional solids. Furthermore, the carrier 10 may be composed of more than two portions to form more complicated shapes, provided that at least two cooperating inner walls 16 enclose and isolate the target 11. For example, in one possible configuration, the target 11 is a sphere of solid material in a spherical recess 19 and the carrier 10 includes portions forming a spherical shell.

FIG. 10 shows the first and second portions 12,14 being attached to each other in the “closed” position of the carrier 10. In this position, the inner surfaces 16A of the inner walls 16 of the first and second portions 12,14 face each other and form a barrier 13A around the irradiated target 11 in the recess 19. The barrier 13A is thus made up of portions of the mass or body of the first and second portions 12,14. The barrier 13A formed helps to maintain or contain the irradiated target 11 in the recess 19 during manipulation and transport of the carrier 10. The barrier 13A formed helps to prevent the movement of the irradiated target 11 in the recess 19 with respect to the first and second portions 12,14. In FIG. 10, the inner surfaces 16A abut against one another, or are in contact with each other, to form the barrier 13A. In an alternate embodiment, the inner surfaces 16A are spaced apart in very close proximity to form the barrier 13A, such that the distance separating them is less than a thickness of the irradiated target 11. The barrier 13A formed by the closed first and second portions 12,14 helps contribute to the sealing engagement of the first and second portions 12,14, which helps to isolate the irradiated target 11 in the recess 19 from the outside environment and reduce or prevent contamination of the irradiated target 11.

The barrier 13A and the thickness of the carrier 10 helps the carrier 10 to act as an integrated energy degrader. The thickness of the first and second portions 12,14, and/or the depth of the recess 19, may be selected to provide the carrier 10 with the desired level of energy degradation. The depth and extent of the recess 19 across both the first and second portions 12,14 may vary, and be selected based on the desired level of energy degradation. In the depicted embodiment, the carrier 10 has an overall thickness of 1.8 mm. The first portion 12 may have a different thickness than the second portion 14, or vice versa, such that the carrier 10 has a different energy degrading effect depending on which outer wall 18 of the first and second portions 12,14 faces the particle beam. This variability may help to produce different isotopes, or may allow for the use of machines with different particle beam energy ranges with the same carrier 10. Thus both the first and second portions 12,14 of the carrier 10 may act as energy degraders depending on which side of the carrier 10 is exposed to the particle beam during irradiation.

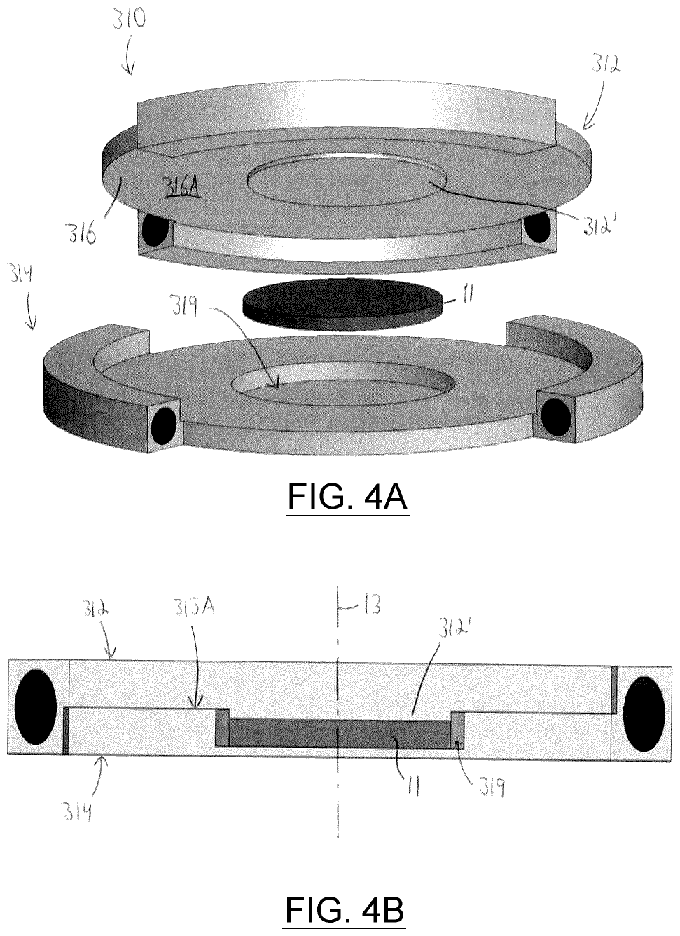

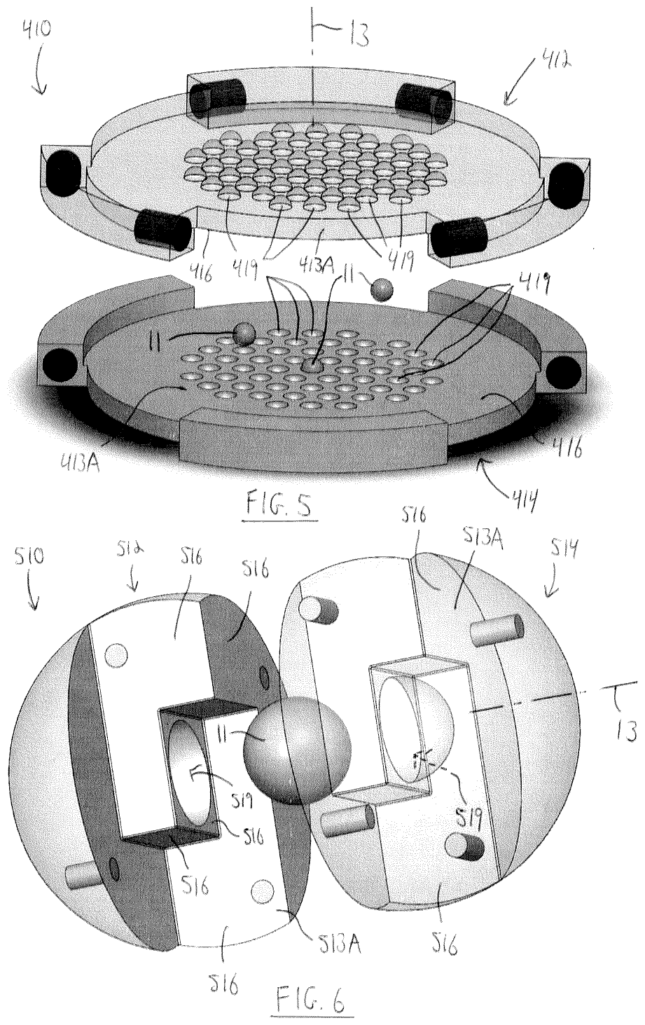

Another possible configuration of the carrier 310 is shown in FIGS. 4A and 4B, and has a varied thickness of the first and second portions 312,314 to achieve the desired energy degradation effect. The first portion 312 includes a central protrusion 312′ which extends outwardly from the inner surface 316A of the inner wall 316 of the first portion 312. The central protrusion 312′ is coaxial with the center axis 13 of the carrier 310. The central protrusion 312′ is round in the depicted embodiment, and has a diameter less than the diameter of the recess 319. The central protrusion 312′ has a diameter equal to the diameter of the target 11. The central protrusion 312′ in the depicted embodiment is integral with the remainder of the first portion 312. In an alternate embodiment, the central protrusion 312′ is a separate component from the first portion 312 and is secured thereto. The central protrusion 312′ increases the thickness of the first portion 312 in area of the recess 319 and the target 11, and adds to the barrier 313A formed by the first and second portion 312,314. The increased thickness of the first portion 312 in its central region may increase its particle energy degradation effect. Features of the carrier 310 shown in FIGS. 4A and 4B which are not annotated with a reference number bear the same reference number as a similar feature shown in the configurations of the carrier 10,110,210 described above and shown in the other figures.

Referring to FIGS. 1A and 1B, the carrier 10 also has a fastening system 20 which helps to maintain the first and second portions 12,14 in sealing engagement, and which also facilitates their separation to reload the carrier 10 with another irradiated target 11 so that the carrier 10 can be reused. The fastening system 20 may be provided, or may have components, on one or both of the first and second portions 12,14. Multiple configurations of the fastening system 20 are possible, and one possible configuration is described in greater detail below.

The carrier 10 thus facilitates the transportation, irradiation and release of the irradiated target 11 for further treatment. The sealing engagement of the first and second portions 12,14 also helps to limit or prevent contamination of the irradiated target 11 during manipulation and transportation of the carrier 11, and helps to limit or prevent the target 11 from contaminating other objects once it has been irradiated. The weakly activable material of the carrier 10 may also help to control the degradation and/or dissipation of thermal energy.

FIGS. 1A and 1B show one possible construction of the first and second portions 12,14 of the carrier 10. The first portion 12 has a first segment 12A extending along a length of a periphery of the first portion 12. The second portion 14 has a second segment 14A extending along a length of a periphery of the second portion 14. The first and second segments 12A,14A are thus peripheral portions or segments of the carrier 10, and may thus take any suitable structure or form, an example of which is now described.

Referring to FIGS. 1A and 1B, each of the first and second segments 12A,14A includes curved inner and outer walls 15A,15B. The curved inner walls 15A are located closer to the center axis 13 than the curved outer walls 15B. The curved inner walls 15A are a portion of the inner walls 16 of the first and second portions 12,14. The curved inner walls 15A are transverse to the planar inner surfaces 16A, and extend outwardly from the planar inner surfaces 16A along a direction of the center axis 13 of the carrier 10. The curved inner walls 15A circumscribe part of the inner surfaces 16A of the first and second portions 12,14. Each of the first and second segments 12A,14A includes first and second connecting walls 15C,15C″ that extend between and connect the curved inner and outer walls 15A,15B. The first connecting walls 15C′ are spaced apart from the inner surfaces 16A along a direction of the center axis 13. The second connecting walls 15C″ are level or flush with the outer walls 18 of the first and second portions 12,14. Each of the first and second segments 12A,14A includes ends walls 15D being transverse to the curved inner and outer walls 15A,15B and to the first and second connecting walls 15C′,15C″. The end walls 15D define peripheral end faces 15D′ of the first and second segments 12A,14A.

Each of the first and second portions 12,14 have intermediate peripheral portions 17 extending between the first and second segments 12A,14A. The intermediate peripheral portions 17 are positioned circumferentially between the first and second segments 12A,14A. The intermediate peripheral portions 17 each have an intermediate peripheral wall 17A that is located closer to the center axis 13 than the curved outer wall 15B of the first and second segments 12A,14A. When the carrier 10 is in the “closed” position, the first and second segments 12A,14A are aligned with each other. When the carrier 10 is in the “closed” position, the first and second segments 12A,14A are coplanar. When the carrier 10 is in the “closed” position, the first and second segments 12A,14A are circumferentially continuous.

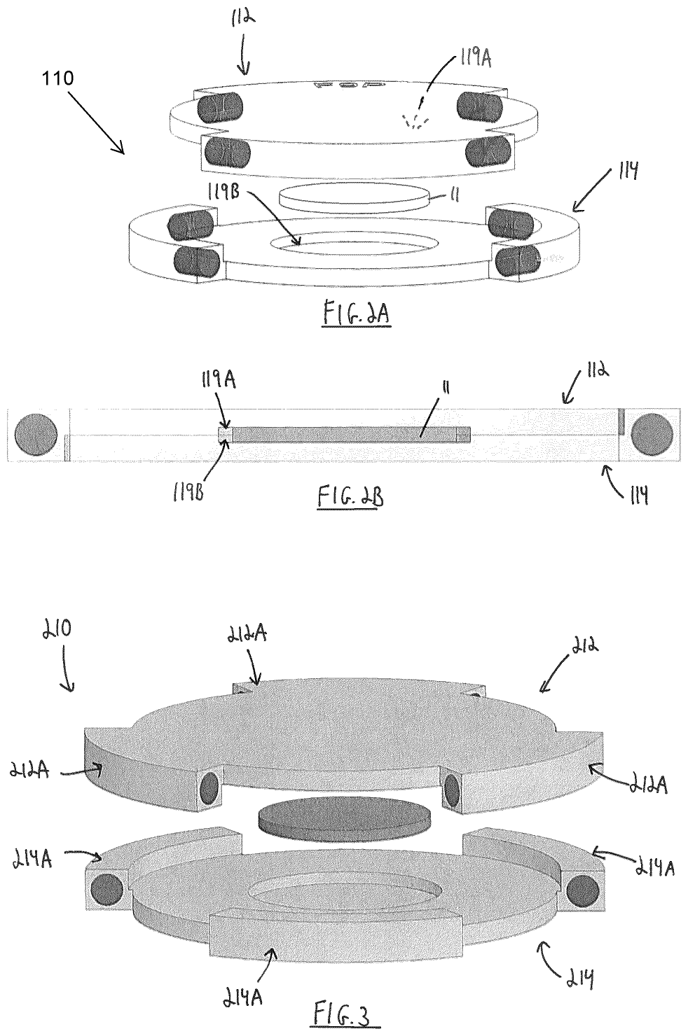

In the depicted embodiment, the outer diameter of the first and second portions 12,14 is about 24 mm, and the carrier 10 has a thickness of 1.8 mm. Other dimensions and shapes for the carrier 10 are possible. For example, in the depicted embodiment, the first and second portions 12,14 are symmetrical about a plane extending through the center axis 13. In an alternate embodiment, the first and second portions 12,14 are asymmetric. In the depicted embodiment, the first portion 12 has two of the first segments 12A, and the second portion 14 has two of the second segments 14A. In an alternate embodiment, the first portion 12 has only one first segment 12A, and the second portion 14 has only one second segment 14A. In yet another possible configuration of the carrier 210, an example of which is shown in FIG. 3, the first portion 212 has more than two of the first segments 212A, and the second portion 214 has more than two of the second segments 214A. Features of the carrier 210 shown in FIG. 3 which are not annotated with a reference number bear the same reference number as a similar feature shown in the configurations of the carrier 10,110 described above and shown in the other figures.

Referring to FIG. 1B, the fastening system 20 includes attachment members 22 in the first and second peripheral segments 12A,14A. The attachment members 22 are attachable to each other to maintain the first and second portions 12,14 in the closed, sealing engagement. The attachment members 22 are also detachable from one another to separate the first and second portions 12,14. In an alternate embodiment, the attachment members 22 are present in only one of the first and second segments 12A,14A.

The attachment members 22 include magnets 24. The magnets 24 are cylindrical stubs or bodies that have a circumferential extent, and they are disposed in the first and second segments 12A,14A of the first and second portions 12,14. The circumferential extent of the magnets 24 is less than the circumferential extent of the first and second segments 12A,14A. Thus, in FIG. 1B, the length of the magnets 24 measured in a circumferential direction is less than the corresponding length of the first and second segments 12A,14A. Each of the first and second segments 12A,14A has two magnets 24 disposed at circumferential opposite ends or extremities of the first and second segments 12A,14A. Each magnet 24 has an exposed magnet face 24A which is level and coplanar with the peripheral end faces 15D′ of the end walls 15D of the first and second segments 12A,14A. In the depicted embodiment, each magnet 24 is a cylindrical body having a diameter of 1.5 mm and a length of 1 mm. Other shapes and dimensions for the magnets 24 are possible.

The magnets 24 of the first segment 12A have a polarity, either a north pole or south pole, that is opposite to the polarity of the magnets 24 of the second segment 14A. The magnets 24 of the first segment 12A are thus drawn to the magnets 24 of the second segment 14A (or vice versa) so that the first and second segments 12A,14A can be attached together in sealing engagement. In the depicted embodiment, when the first and second portions 12,14 are attached together, the first segments 12A of the first portion 12 are positioned in the intermediate peripheral portions 17 of the second portion 14, and the second segments 14A of the second portion 14 are positioned in the intermediate peripheral portions 17 of the first portion 12. The exposed magnet faces 24A of the first portion 12 are thus brought into proximity and contact with the exposed magnet faces 24A of the second portion 14, and are drawn together because of their opposed polarity. The first and second segments 12A,14A are thus coupled together, and the first and second portions 12,14 are attached. In the depicted embodiment, the carrier 10 is a magnetic target carrier 10, and has a magnetic fastening system 20.

The magnets 24 may also be encoded using the north and south poles to force a particular fastening of the first and second portions 12,14. For example, the magnets 24 of the first portion 12 have both north and south poles, and the magnets 24 of the second portion 14 also have both north and south poles, such that the first and second portions 12,14 may only be coupled together in a specific way. This encoding, in conjunction with the shape of the carrier 10, may be used to distinguish different carriers 10 from one another in situations where multiple types of carriers 10 are used to prevent erroneous combination of parts between different models.

The abutting exposed magnet faces 24A and peripheral end faces 15D′ of the first and second segments 12A,14A also provide an anti-rotation function by blocking the rotation of the first and second segments 12A,14A, and thus the rotation of the first and second portions 12,14, about the center axis 13. The configuration of the first and second segments 12A,14A shown in FIGS. 1A and 1B contribute to the sealing engagement of the first and second portions 12,14. More particularly, the abutting exposed magnet faces 24A and peripheral end faces 15D′, and the positioning of the first and second segments 12A,14A in the intermediate peripheral portions 17, extend the barrier 13A outwardly from the center axis 13 to the circumferential periphery of the carrier 10, preventing the ingress of contaminants past the periphery of the carrier 10. Other configurations for the attachment members 22 are possible and within the scope of the present disclosure. For example, the attachment members 22 may be mechanical components, such as a female and a male component.

Still referring to FIGS. 1A and 1B, all of the recess 19 is spaced apart from the first and second segments 12A,14A. The recess 19 is spaced inwardly from the first and second segments 12A,14A. The recess 19 is spaced closer to the center axis 13 than the first and second segments 12A,14A. The irradiated target 11 in the recess 19 is thus spaced inwardly from the outer periphery of the carrier 10, thereby helping to further isolate it from contaminants originating from outside the carrier 10.

FIG. 5 shows another possible configuration of the carrier 410. Features of the carrier 410 shown in FIG. 5 which are not annotated with a reference number bear the same reference number as a similar feature shown in the configurations of the carrier 10,110,210,310 described above and shown in the other figures. The carrier 410 has multiple recesses 419 extending inwardly from the inner walls 416 of both the first and the second portions 412,414. The recesses 419 are spaced apart from each other. The recesses 419 are spaced apart from each other in a direction parallel to a plane defined by the inner walls 416. In FIG. 5, the recesses 419 each have a hemispherical shape. In FIG. 5, each of the recesses 419 in one of the first and second portions 412,414 is aligned with a corresponding recess 419 in the other of the first and second portions 412,414 in a direction along the center axis 13 of the carrier 410. Therefore, when the carrier 410 is “closed” such that the first and second portions 412,414 are removably attached and in sealing engagement, each of the recesses 419 in the first and second portions 412,414 forms a spherical void to receive therein one or more solid spherical targets 11. The barrier 413A is formed around each target 11 in each recess 419 when the carrier 410 is closed. This configuration of a “distributed target” carrier 410 allows for multiple targets 11 to be irradiated in the same carrier 410, such as by an accelerated particle beam having a given energy, to form the irradiated targets 11. Such distributed processing of multiple targets 11 in a single carrier 410 may be suitable where the surface exposure of the target 11 or the material of the target 11 is better suited to distribution in smaller portions.

FIG. 6 shows another possible configuration of the carrier 510. Features of the carrier 510 shown in FIG. 6 which are not annotated with a reference number bear the same reference number as a similar feature shown in the configurations of the carrier 10,110,210,310,410 described above and shown in the other figures. In FIG. 6, the carrier 510 forms a sphere when the first and second portions 512,514 are attached and in sealing engagement. The first and second portions 512,514 are spherically shaped. The first and second portions 512,514 have shapes resembling hemispheres, with portions thereof missing and defining multiple inner walls 516 for each of the first and second portions 512,514. Some of the inner walls 516 of each of the first and second portions 512,514 are perpendicular to each other, and mate with corresponding planar inner walls 516 on the other portion 512,514. The carrier 510 has two recesses 519 extending inwardly from one of the inner walls 516 of both the first and the second portions 512,514. The recesses 519 each have a hemispherical shape. In FIG. 6, the recess 519 in one of the first and second portions 512,514 is aligned with the other recess 519 in the other of the first and second portions 512,514 in a direction along a center axis 13 of the carrier 510. Therefore, when the carrier 510 is “closed” such that the first and second portions 512,514 are removably attached and in sealing engagement, the recesses 519 in the first and second portions 512,514 form a spherical void to receive therein a solid spherical target 11. The barrier 513A is formed by the body of the first and second portions 512,514 around the target 11 in the recesses 519 when the carrier 510 is closed. This configuration of a spherical target carrier 510 may allow for multiple energy beams of different strengths to bombard the target 11 simultaneously. This configuration of a spherical target carrier 510 may help accommodate non-uniform energy beams for energy degradation.

FIG. 9 shows another possible configuration of the carrier 710. Features of the carrier 710 shown in FIG. 9 which are not annotated with a reference number bear the same reference number as a similar feature shown in the configurations of the carrier 10,110,210,310,410,510 described above and shown in the other figures. In FIG. 9, the carrier 710 is a rectangular prism with cylindrically-shaped recesses 719. The first portion 712 of the carrier 710 is made up of, or includes, multiple first portion segments 712A, one of which is shown transparent to illustrate the structure and internal features of the first portion segments 712A. FIG. 9 shows three first portion segments 712A, but more or fewer are possible. The attachment member 722 (magnets 724 in FIG. 9) of each first portion segment 712A mates with an attachment member 722 of the second portion 714. The second portion 714 in FIG. 9 is an elongated, rectangular prism having multiple recesses 719 spaced apart from each other along the length of the second portion 714. When one of the first portion segments 712A is mated with the corresponding part of the second portion 714, the sealing engagement and barrier 713A described above is formed around the target 11 in the recess 719. The first portion segments 712A may have different thicknesses or shapes depending on the desired level of energy degradation. Each first portion segment 712A is attachable to the second portion 714 independently of the other first portion segments 712A. Each first portion segment 712A is separable or detachable from the second portion 714 independently of the other first portion segments 712A. Not all of the first portion segments 712A need to be used with a corresponding target 11, such that the carrier 710 may have more recesses 719 than targets 11. This configuration of a “distributed target” carrier 710 allows for multiple targets 11 to be irradiated in the same carrier 710, such as by an accelerated particle beam having a given energy, to form the irradiated targets 11. Once irradiated, the targets 11 may be released from the carrier 710 sequentially by detaching or opening each of the first portion segments 712A in sequence. This may be done in order to dissolve all the targets 11 in a single reactor, after appropriate cleaning to avoid cross-contamination. Alternatively, each of the irradiated targets 11 may be released from the carrier 710 in “parallel” into their own reactors for dissolution by detaching or opening each of the first portion segments 712A. In view of FIG. 9, it will be appreciated that the shapes of the carrier 10,110,210,310,410,510,710 disclosed herein include rounded/circular shapes, as well as polygonal/planar shapes.

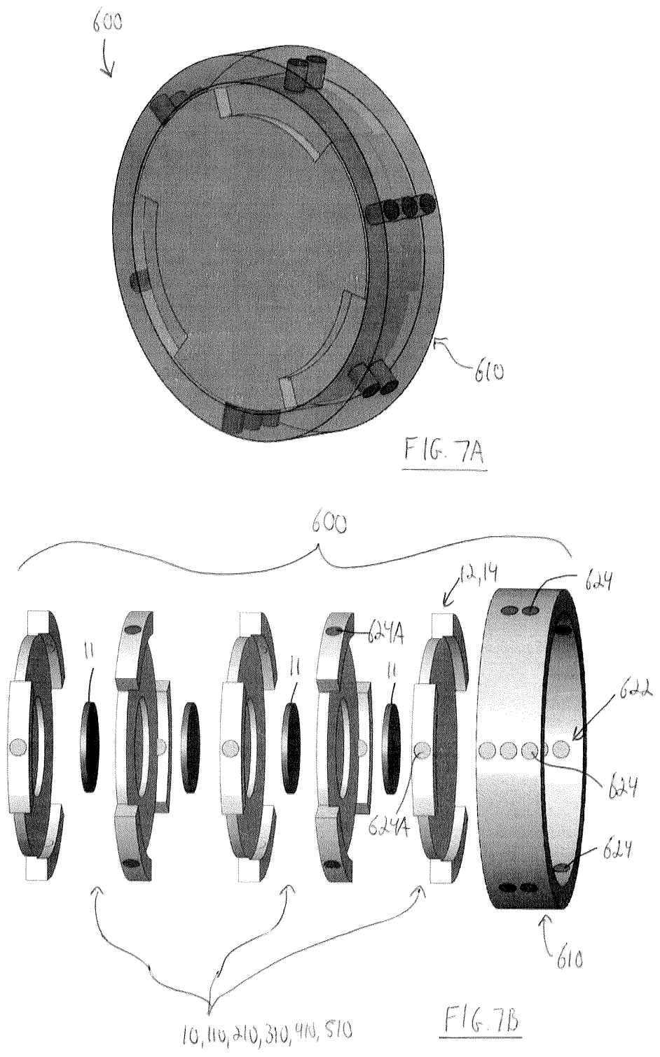

FIGS. 7A and 7B show a stack 600 of carriers 10,110,210,310,410,510,710. The features of the carriers 10,110,210,310,410,510,710 shown in FIGS. 7A and 7B which are not annotated with a reference number bear the same reference number as a similar feature shown in the configurations of the carrier 10,110,210,310,410,510,710 described above and shown in the other figures. The stack 600 includes multiples carriers 10,110,210,310,410,510,710 stacked one against the next, and assembled together by a collar or sleeve 610. The sleeve 610 includes attachment members 622, which in FIGS. 7A and 7B are magnets 624, to removably engage peripheral magnets 624A of the carriers 10,110,210,310,410,510,710. Each carrier 10,110,210,310,410,510,710 may include its own target 11. Some of the carriers 10,110,210,310,410,510,710 include only a portion of the carrier 10,110,210,310,410,510,710, such as the first or second portions 12,14. When the sleeve 610 is removed from the carriers 10,110,210,310,410,510,710, the carriers 10,110,210,310,410,510,710 can be disassembled and their targets 11 released. The stack 600 may have any desired orientation. The “stack of target carriers” 600 may allow for multiple targets 11 to be irradiated by a single or the same energy beam at different energy levels. The stack 600 may allow for producing different irradiated targets 11, and thus different radio-isotopes, in a single bombardment of an energy beam. Each target 11 in the stack 600 may be made from a different precursor material and would be exposed to different energy levels as the single energy beam traveled through the stack 600 along its length because the stacked targets 11 and the stacked barriers 13A formed by the carriers 10,110,210,310,410,510,710 contribute cumulatively to the degradation of the energy of the beam. The resulting effect may be equivalent to bombarding each of the targets 11 with its own energy beam having its own energy level.

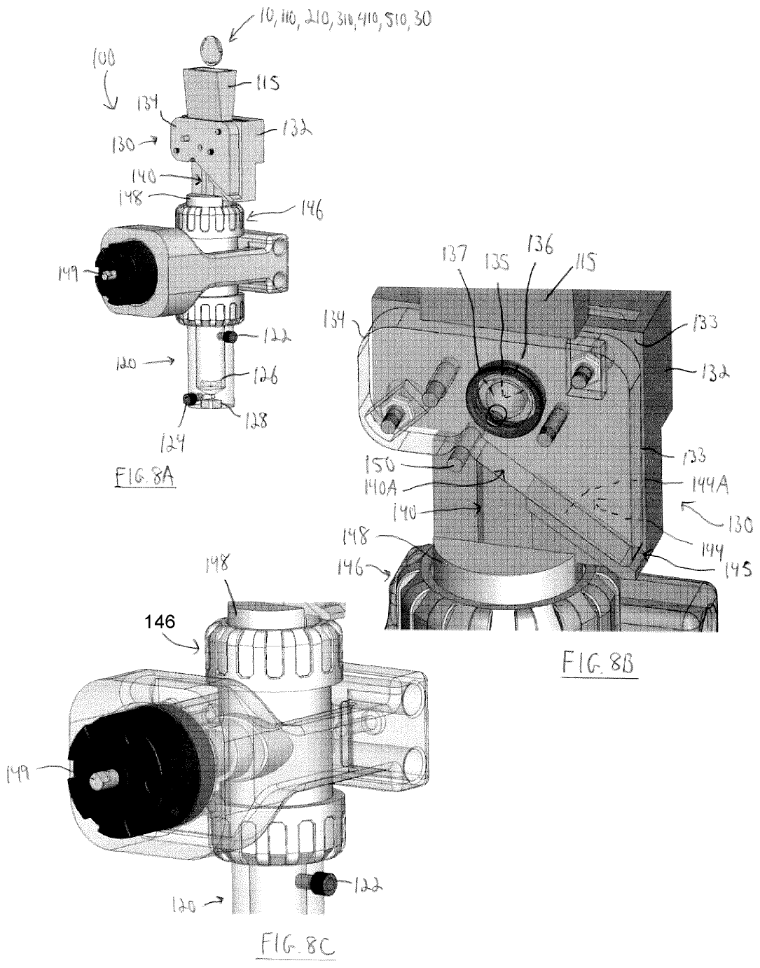

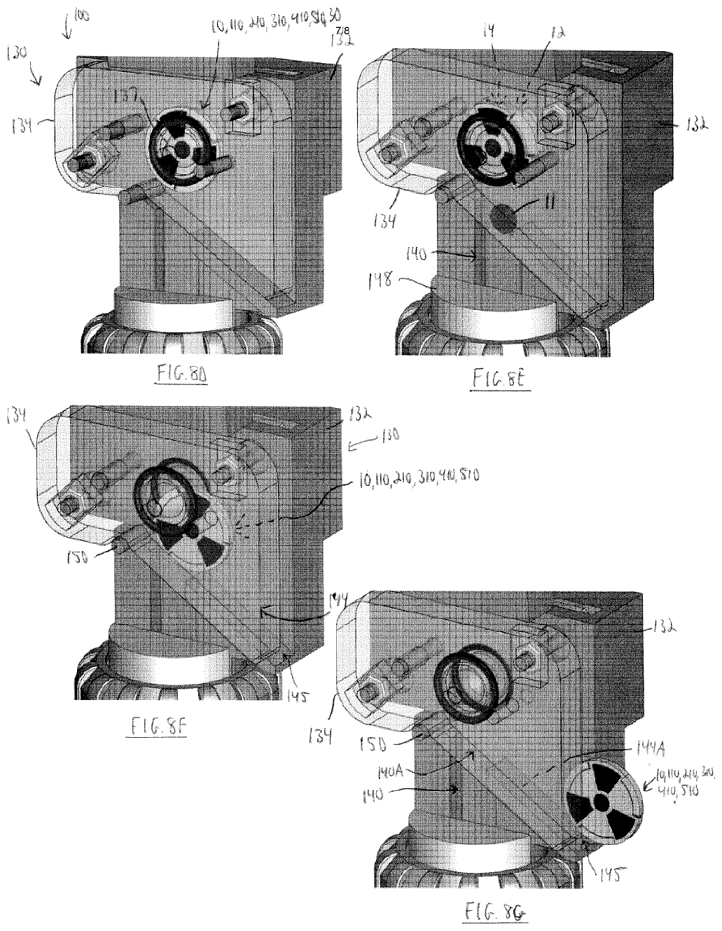

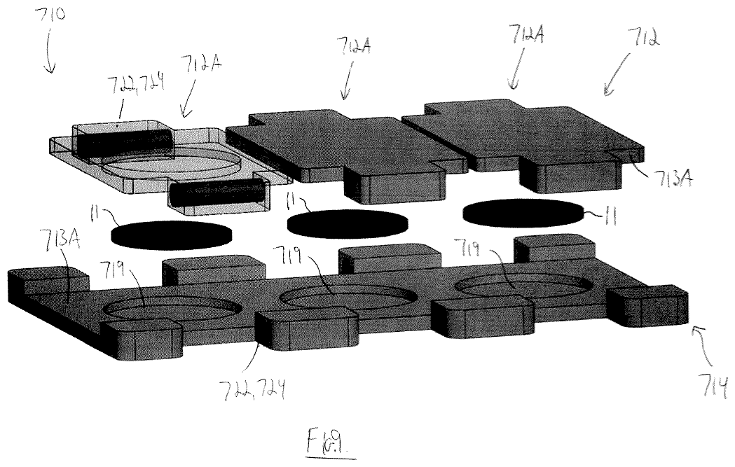

When the carrier 10,110,210,310,410,510,710 contains the irradiated target 11, it forms a kit 30 that can be used for additional processing, which is now described in further detail with reference to FIGS. 8A to 8C.

FIGS. 8A to 8C show a dissolution system 100 for producing a liquid target solution from the irradiated target 11 contained in the carrier 10,110,210,310,410,510,710. The irradiated target 11 (which comprises ⁶⁸Zn, ⁶⁸Ga and other radionuclides, for example) is released from the carrier 10,110,210,310,410,510,710 into a reactor 120 or other suitable fluid container which contains an appropriate solvent (in solution) capable of dissolving the irradiated target 11. Details of the solvent and the further processing of the solution are provided in International patent application having application number PCT/CA2019/051777 filed Dec. 10, 2019, and in US provisional patent application having application No. 62/777,994 and filed on Dec. 11, 2018, the entire contents of both of which are incorporated by reference herein. In the illustrated embodiment, the reactor 120 is a vial or a vessel that has an upper opening for receiving the irradiated target 11, and has a gas line 122 and a liquid line 124. The reactor 120 has a stirring bar 126 and a stirring plate 128.

The system 100 has a grip assembly 130 which in operation receives the carrier 10,110,210,310,410,510,710 containing the irradiated target 11, and manipulates the target carrier 10,110,210,310,410,510,710 to extract the irradiated target 11 and release it into the solvent contained in the reactor 120. The grip assembly 130 includes a first plate 132 and a second plate 134 which are displaceable relative to one another. In the depicted embodiment, the first and second plates 132,134 are both displaceable toward and away from each other. In an alternate embodiment, only one of the first and second plates 132,134 is displaceable toward and away from the other one of the first and second plates 132,134. The first and second plates 132,134 are interconnected by suitable structure to facilitate or coordinate their relative displacement. The first and second plates 132,134 are relatively displaced using any suitable technique. One possible technique involves using pneumatic actuators. Each of the first and second plates 132,134 have facing inner surfaces 133 which are displaced relative to each other toward and away from each other. The first and second plates 132,134 are relatively displaceable between a closed position and an open position. The system 100 may have a tapered chute 115 for receiving the carrier 10,110,210,310,410,510,710 and guiding it to the first and second plates 132,134.

In the open position, the inner faces 133 of the first and second plates 132,134 are spaced apart to define a gap to receive the magnetic target carrier 10,110,210,310,410,510,710 containing the irradiated solid target 11 (i.e. the kit 30). The kit 30 is supported by one or both of the first and second plates 132,134. The support can take any suitable form. For example, in the depicted embodiment, each of the first and second plates 132,134 has a cavity 135 extending inwardly from the inner surfaces 133. The annular cavity 135 receives an O-ring seal 136 therein. The O-ring seals 136 delimit a vacuum orifice 137 extending through each of the first and second plates 132,134. A negative-pressure source, such as a vacuum, is in fluid connection with each of the vacuum orifices 137 via one or more pneumatic lines to create a negative pressure at the vacuum orifices 137. The negative-pressure source may also be configured to provide a positive pressure, or “jet” of air, through the vacuum orifices 137. When the outer wall 18 of the carrier 10,110,210,310,410,510,710 is placed over the vacuum orifice 137, the negative pressure behind the outer wall 18 supports the kit 30 against one or both of the first and second plates 132,134.

In the closed position, the first and second plates 132,134 and their inner surfaces 133 are brought closer together compared to when they are in the open position. In the closed position, the first and second plates 132,134 grip the first and second portions 12,14 of the carrier 10,110,210,310,410,510,710, such as by using the negative pressure created at the vacuum orifices 137. Since the first and second portions 12,14 are gripped by the first and second plates 132,134, respectively, the displacement of the first and second plates 132,134 from the closed position to the open position will separate the first and second portions 12,14 of the carrier 10,110,210,310,410,510,710 from each other, to release the irradiated target 11 into the solution contained in the reactor 120. After the irradiated target 11 has been released from the carrier 10,110,210,310,410,510,710, the first and second plates 132,134 are then displaced from the open position to the closed position to attach the first and second portions 12,14 back together again. The reassembled carrier 10,110,210,310,410,510,710 may then be discharged from the system 100, as described in greater detail below. The presence of the magnetic fastening system 20 in an embodiment of the carrier 10,110,210,310,410,510,710 allows for the easy opening of the carrier 10,110,210,310,410,510,710 and its subsequent reassembly by the relative displacement of the first and second plates 132,134.

The movement of the irradiated solid target 11 from the grip assembly 130 to the reactor 120 is controllable. The system 100 also has a passage 140 extending between the reactor 120 and the grip assembly 130. The irradiated target 11 released from the carrier 10,110,210,310,410,510,710 is conveyed along the passage 140 to be received in the solution of the reactor 120. A closure member 146 may be present in, or engageable with, the passage 140 to obstruct and open the passage to selectively communicate the irradiated target 11 released from the grip assembly 130 to the reactor 120. The closure member 146 can have any suitable configuration to achieve such functionality. For example, in the depicted embodiment, the closure member 146 includes a valve 148 to selectively obstruct and open the passage 140. The valve 148 in FIGS. 8A to 8C is a pneumatically-activated ball valve in fluid communication with a source of air via the valve supply line 149.

Referring to FIG. 8B, a carrier passage 144 extends between the first and second plates 132,134 and a discharge outlet 145 of the system 100 to convey the carrier 10,110,210,310,410,510,710, after it has released the irradiated target 11, away from the gripping assembly 130. The closure member 146 may engage the passage 140 to direct the emptied carrier 10,110,210,310,410,510,710 released from first and second plates 132,134 along the carrier passage 144 toward the discharge outlet 145. Alternatively, and as shown in FIG. 8B, the width of the opening 140A of the passage 140 is less than the diameter of the carrier 10,110,210,310,410,510,710. Therefore, when the carrier 10,110,210,310,410,510,710 is released from the gripping assembly 130, it will abut against the walls defining the opening 140A to the passage 140, and roll along the inclined ramp surface 144A of the carrier passage 144 toward the discharge outlet 145. The gripping assembly 130 in FIG. 8B includes a guide rod 150 at an upper end of the carrier passage 144. The guide rod 150 is impacted by the carrier 10,110,210,310,410,510,710 when it is released from the first and second plates 132,134 and obstructs movement of the released carrier 10,110,210,310,410,510,710 in a direction away from the discharge outlet 145, such that the released carrier 10,110,210,310,410,510,710 is forced by gravity to roll along the inclined ramp surface 144A of the carrier passage 144 toward the discharge outlet 145.

FIGS. 8D to 8G show one possible sequence of events which result in the target 11 being released from the gripping assembly 130 and in the carrier 10,110,210,310,410,510,710 being discarded by the dissolution system 100. Referring to FIG. 8D, when the first and second plates 132,134 are in the closed position, the first and second plates 132,134 grip the first and second portions 12,14 of the carrier 10,110,210,310,410,510,710, such as by using the negative pressure created at the vacuum orifices 137. FIG. 8E shows the displacement of the first and second plates 132,134 from the closed position to the open position, which causes the gripped first and second portions 12,14 of the carrier 10,110,210,310,410,510,710 to separate from each other and release the irradiated target 11 into the passage 140 leading to the solution contained in the reactor 120. After the irradiated target 11 has been released from the carrier 10,110,210,310,410,510,710, the first and second plates 132,134 are then displaced from the open position to the closed position to attach the first and second portions 12,14 back together again, as shown in FIG. 8F. The reassembled carrier 10,110,210,310,410,510,710 may then be discharged from the system 100 by being released from the gripping assembly 130. The release of the reassembled carrier 10,110,210,310,410,510,710 may be performed using different techniques. One possible technique involves applying positive pressure from the vacuum orifice 137 of the first plate 132 to force the reassembled carrier 10,110,210,310,410,510,710 against the second plate 134, while simultaneously displacing the first plate 132 away from the second plate 134 to increase the gap therebetween. Then, the second plate 134 is displaced away from the first plate 132 and a positive pressure is applied from the vacuum orifice 137 of the second plate 134 to push the reassembled carrier 10,110,210,310,410,510,710 away from the second plate 134. Referring to FIGS. 8F and 8G, when the reassembled and empty carrier 10,110,210,310,410,510,710 is released by the first and second plates 132,134, it will abut against the walls defining the opening 140A to the passage 140, and be induced by the guide rod 150 to roll along the inclined ramp surface 144A of the carrier passage 144 toward the discharge outlet 145.

The operation of the system 100 may be automated to automate the radiosynthesis of ⁶⁸Ga for large-scale and routine production using a ⁶⁸Zn pressed target.

Referring to FIGS. 8D to 8G, there is also disclosed a method of producing a solution of the irradiated target 11. In the method, the kit 30 (i.e. the magnetic target carrier 10,110,210,310,410,510,710 with the irradiated target 11) is provided in the gap between the first and second plates 132,134 when they are in the open position. The first and/or second plates 132,134 are actuated to begin their relative displacement to squeeze the carrier 10,110,210,310,410,510,710 in the closed position. The vacuum orifice 137 is activated to create a negative pressure along the outer walls 18 of the first and second portions 12,14 of the carrier 10,110,210,310,410,510,710. The valve 148 is opened to unblock the passage 140 leading to the reactor 120. The first and second portions 12,14 of the carrier 10,110,210,310,410,510,710 are separated from each other by displacing the first and second plates 132,134 from the closed position to the open position. This releases the irradiated target 11, which falls along the passage 140 and into the solution of the reactor 120, where it becomes a solution once dissolution is completed. The valve 148 may be closed to block the passage 140. The valve 148 is thus operable to selectively block (and unblock) the passage 140. The first and second portions 12,14 are reassembled by relatively displacing the first and second plates 132,134 from the open position to the closed position. The first and second plates 132,134 are relatively displaced from the closed position to the open position, and/or the vacuum orifice 137 is deactivated, to release the emptied carrier 10,110,210,310,410,510,710 from the gripping assembly 130 so that it is discharged along the carrier passage 144 and out the discharge outlet 145. In an embodiment, both of the vacuum orifices 137 apply a positive pressure or jet of air to force first and second portions 12,14 of the carrier 10,110,210,310,410,510,710 away from first and second plates 132,134 to be discharged. Referring to FIGS. 8A to 8C, the desired reaction may take place in the reactor 120, and the resulting solution evacuated from the reactor 120 via the liquid line 124 by negative pressure and/or by positive pressure provided through the gas line 122. For example, the valve 148 may be closed, and gas may be injected into the reactor 120 via the gas line 122 to increase the pressure within the reactor 120, and force the solution out of the reactor 120 via the liquid line 124. The solution may be transferred via the liquid line 124 to a downstream device for use or processing.

The above description is meant to be exemplary only, and one skilled in the art will recognize that changes may be made to the embodiments described without departing from the scope of the invention disclosed. For example, any of the carriers 10,110,210,310,410,510,710 and their recesses 19 may be shaped to offer a non-uniform density profile to help accommodate non-uniform energy beams for energy degradation. Still other modifications which fall within the scope of the present invention will be apparent to those skilled in the art, in light of a review of this disclosure, and such modifications are intended to fall within the appended claims.

1. A carrier for an irradiated target, comprising:
a first portion and a second portion having inner walls and one or both of the first and second portions having a recess extending inwardly from the inner wall thereof to receive the irradiated target, the first and second portions being removably attachable in sealing engagement, the inner walls facing each other and forming a barrier around the recess upon the first and second portions being removably attached; and
a fastening system provided on one or both of the first and second portions to maintain the first and second portions in sealing engagement.

2. The carrier of claim 1, wherein the first portion has a first segment extending along a length of a periphery of the first portion, the second portion has a second segment extending along a length of a periphery of the second portion, the fastening system including attachment members of the first and second segments, the attachment members being removably attachable to maintain the first and second portions in sealing engagement.

3. The carrier of claim 2, wherein the first and second segments are aligned upon the first and second portions being in sealing engagement.

4. The carrier of claim 2, wherein the attachment members include magnets, the magnets of the first segment having a first polarity and the magnets of the second segment having a second polarity opposite to the first polarity.

5. The carrier of claim 4, wherein the magnets are disposed within the first and second segments, the magnets having a length less than a length of the first and second segments.

6. The carrier of claim 4, wherein the magnets define exposed magnet faces for the first and second segments, the exposed magnet face of the first segment abutting the exposed magnet face of the second segment upon the first and second portions being in sealing engagement.

7. The carrier of claim 2, wherein the recess is spaced apart from the first and second segments.

8. The carrier of claim 1, wherein the first and second portions are rounded and define a center axis of the carrier, the recess being coaxial with the center axis.

9. The carrier of claim 1, wherein the first and second portions are made from a weakly activable material being aluminum (Al).

10. The carrier of claim 1, wherein the first and second portions are made from a weakly activable material being one of aluminum (Al), Niobium (Nb), Silver (Ag), Tantalum (Ta), Rhodium (Rh), Platinum (Pt), Copper (Cu) and alumina ceramic.

11. The carrier of claim 1, wherein one or both of a thickness of the barrier and a depth of the recess are selected to provide the carrier with an energy degradation effect.

12. The carrier of claim 1, wherein a thickness of the barrier is selected to provide the carrier with an energy degradation effect.

13. The carrier of claim 12, wherein the thickness of the first portion is different from a thickness of the second portion to provide the carrier with the energy degradation effect.

14. The carrier of claim 1, wherein the recess is a first recess extending inwardly from the inner wall of the first portion, the second portion having a second recess extending inwardly from the inner wall of the first portion and aligned with the first recess.

15. The carrier of claim 1, wherein the recess is a first recess extending inwardly from the inner wall of the first or second portions, the first and second portions having a plurality of other recesses extending inwardly from the inner walls of the first or second portions, the plurality of other recesses spaced apart from each other and from the first recess.

16. The carrier of claim 1, wherein the first and second portions are spherically shaped, the first and second portions being removably attachable in sealing engagement to form the carrier having a spherical shape.

17. A kit, comprising:
a solid irradiated target; and
a carrier for the solid irradiated target, the carrier comprising:
a first portion and a second portion having inner walls and one or both of the first and second portions having a recess extending inwardly from the inner wall thereof and containing the solid irradiated target, the first and second portions being removably attached in sealing engagement and separable from each other, the inner walls facing each other and forming a barrier around the solid irradiated target in the recess; and
a fastening system provided on one or both of the first and second portions to maintain the first and second portions in sealing engagement.

18. The kit of claim 17, wherein the solid irradiated target is a disc or a sphere.

19. The kit of claim 17, wherein the solid irradiated target has a first diameter and the recess has a second diameter greater than the first diameter.

20.-38. (canceled)

39. A dissolution system for producing a solution of irradiated target, the system comprising:
a reactor shaped and sized to contain a solvent for dissolving the irradiated target;
a grip assembly having a first plate displaceable relative to a second plate between an open position and a closed position, the first and second plates in the open position defining an opening therebetween to receive a carrier containing the irradiated target, the first and second plates in the closed position gripping the carrier, displacement of the first and second plates from the closed position to the open position separating portions of the carrier to release the irradiated target therefrom; and
a passage extending between the reactor and the grip assembly to selectively communicate the irradiated target released from the grip assembly to the reactor.

40.-54. (canceled)
